(19) United States
(12) Patent Application Publication
(10) Pub. No.: US 2008/0241649 A1
(43) Pub. Date: Oct. 2, 2008

(54) SMALL ELECTRONIC DEVICE

(75) Inventors: Katsushige KOHRI, Osaka-shi (JP); Tadashi INOUE, Neyagawa-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/059,697

(22) Filed: Mar. 31, 2008

(30) Foreign Application Priority Data
Mar. 30, 2007 (JP) 2007-093792

(51) Int. Cl. H01M 2/10

(52) U.S. Cl. 429/96

(57) ABSTRACT

The present invention provides a small electronic device including a cabinet body having a battery chamber defined therein, and a battery pack having a battery that is to be received in the battery chamber and is integrated with a battery lid for covering the battery chamber. The battery lid is detachably engaged with the cabinet body. A support plate for receiving the battery is placed on the bottom face of the battery chamber. An opening is centrally defined on the support plate.

The priority application Number 2007-093792 upon which this patent application is based is hereby incorporated by reference.

### BACKGROUND OF THE INVENTION

1. Field of the Invention

The present invention relates to small electronic devices such as portable telephones.

2. Description of Related Art

A conventional portable telephone includes, as shown in FIG. 5, a cabinet body 101 having a battery chamber defined therein, and a battery pack 103 having a battery 108 to be received in the battery chamber and a battery lid 109 for covering the battery chamber that are integrated together by ultrasonic welding.

The cabinet body 101 includes two side plate portions 110, 110 at both ends, and has a support plate 111 placed on the bottom of the battery chamber. The battery pack 103 is detachably attached in the battery chamber of the cabinet body 101.

The battery 108 includes a battery body 112 and a battery case 113 storing the battery body 112. As shown in FIG. 6, the battery lid 109 includes a main plate portion 114 and two side plate portions 115, 115 projecting from both ends of the main plate portion 114. The battery lid 109 has the battery 108 and the main plate portion 114 of the battery lid 109 integrated together by ultrasonic welding.

However, there has been a problem of a gap G, as shown in FIG. 5, being defined between the side plate portions 110, 110 of the cabinet body 101 and the side plate portions 115, 115 of the battery lid 109. This can be caused by the battery pack 103 being used under high temperature and high humidity environments and the battery 108 being thereby expanded in the thickness direction as indicated by a two-dot chain line in FIG. 7, resulting in the battery 108 expanded in the thickness direction pressing the support plate 111 and pushing up the battery lid 109.

### SUMMARY OF THE INVENTION

The present invention provides a small electronic device including a cabinet body having a battery chamber R, and a battery pack having a battery that is to be received in the battery chamber R and is integrated with a battery lid for covering the battery chamber R. The battery lid is detachably engaged with the cabinet body. A support plate for receiving the battery is placed on the bottom face of the battery chamber R. An opening is centrally defined on the support plate.

The small electronic device of the present invention can prevent the battery lid from being pushed up because the opening is centrally defined on the support plate and therefore the expanded portion of the battery pack expanded in the thickness direction is received in the opening. The side plate portions of the battery lid and the side plate portions of the cabinet body will therefore not define a gap G.

In another specific configuration, the support plate is made of metal. This specific configuration allows the support plate to have mechanical strength equivalent to or greater than that in the case of use of a synthetic resinous material, as well as allowing the support plate to be thinner.

In still another specific configuration, a first substrate and a second substrate are arranged on opposite sides across the battery chamber R inside the cabinet body, with one of the substrates being connected to a ground potential. The first substrate and the second substrate are electrically connected to each other by the support plate. This specific configuration allows both the first substrate and the second substrate to be connected to a ground potential.

In still another specific configuration, the first substrate is an antenna substrate having an antenna incorporated therein, and the second substrate is a high frequency substrate for performing communication processing using the antenna. This specific configuration can reduce noise during communication by the antenna substrate and the high frequency substrate.

As described above, the small electronic device of the present invention will not have a gap defined between the side plate portions of the cabinet body and the side plate portions of the battery lid even in use under high temperature and high humidity environments.

### BRIEF DESCRIPTION OF THE DRAWINGS

FIG. 1 is a perspective view of a foldable portable telephone of the present invention;

FIG. 2 is an exploded perspective view of an operation housing of the foldable portable telephone;

FIG. 3 is an exploded perspective view showing a battery pack;

FIG. 4 is a sectional view of the operation housing in the portable telephone embodying the present invention;

FIG. 5 is a sectional view of an operation housing in a conventional portable telephone;

FIG. 6 is a perspective view showing a battery lid and a battery that are to be ultrasonically welded; and

FIG. 7 is a sectional view showing an expanded battery.

### DETAILED DESCRIPTION OF THE INVENTION

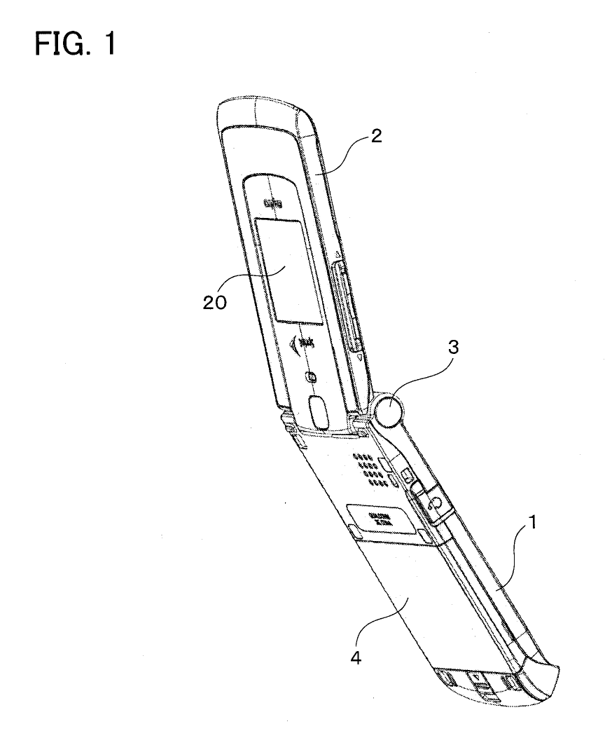

The present invention embodied in a foldable portable telephone is now described with reference to the drawings. As shown in FIG. 1, a foldable portable telephone of the present invention has an operation housing 1 and a display housing 2 that are openably and closably coupled to each other via a hinge mechanism 3.

The operation housing 1 includes a battery pack 4, and has a plurality of operation buttons (not shown) arranged on the facing surface to the display housing 2. The display housing 2 has a main display (not shown) arranged on the facing surface to the operation housing 1, and has a sub display 20 arranged on the back face of the display housing 2.

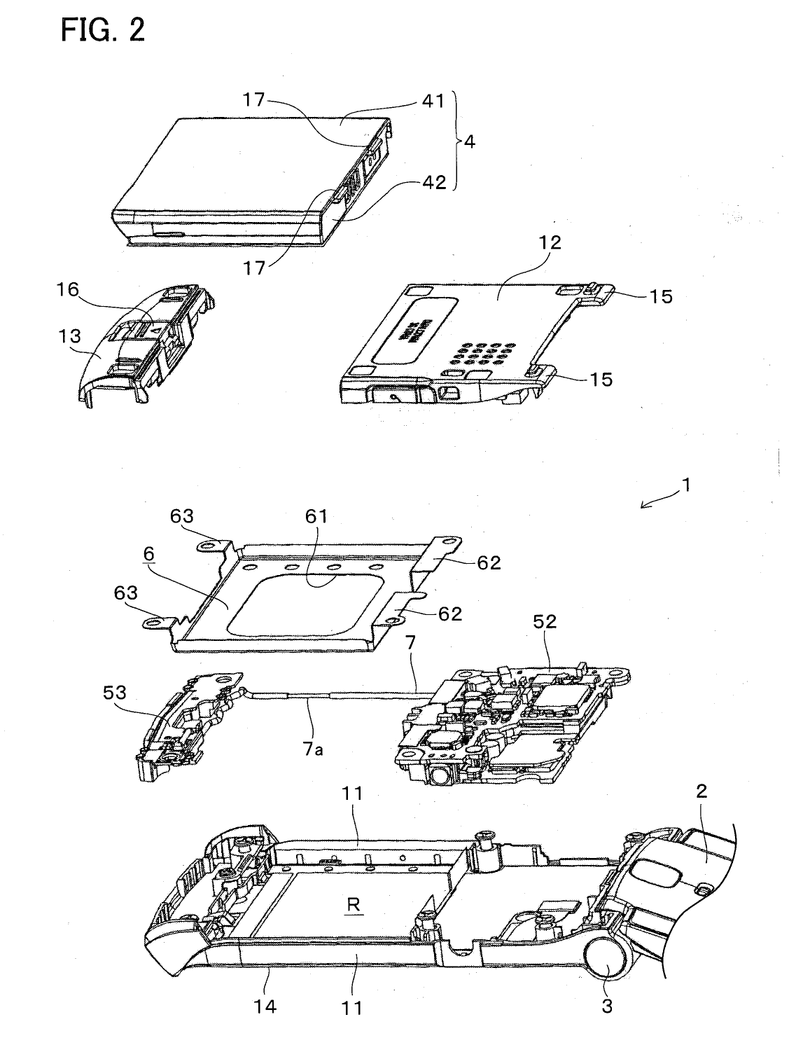

As shown in FIG. 2, the foldable portable telephone of the present invention includes a cabinet body 14 of the operation housing 1 that includes a battery chamber R and two side plate portions 11, 11 projecting from both ends of the battery chamber R. The cabinet body 14 has an antenna substrate 53 and a high frequency substrate 52 that are arranged on opposite sides across the battery chamber R. The antenna substrate 53 and the high frequency substrate 52 are electrically connected to each other by a coaxial cable 7. The coaxial cable centrally includes a wire exposed portion 7a for grounding.

A support plate 6 made of stainless steel and centrally having an opening 61 is placed in the battery chamber R. Two first coupling pieces 62, 62 and two second coupling pieces 63, 63 project from both ends of the support plate 6. The two first coupling pieces 62, 62 are coupled to the high frequency substrate 52, and the two second coupling pieces 63, 63 are coupled to the antenna substrate 53.

The support plate 6 supports the antenna substrate 53 and the high frequency substrate 52 via the first coupling pieces 62, 62 and the second coupling pieces 63, 63. The coaxial cable 7 is placed between the support plate 6 and the bottom of the battery chamber R.

The support plate 6 is electrically connected to the wire exposed portion 7a of the coaxial cable 7 to thereby connect the antenna substrate 53 and the high frequency substrate 52 to a ground potential via the support plate 6. Further, heat dissipation effect on the high frequency substrate 52 is given by the support plate 6 being coupled to the high frequency substrate 52 via the first coupling pieces 62, 62.

The antenna substrate 53 is covered with an antenna substrate cover 13. The high frequency substrate 52 is covered with a high frequency substrate cover 12. Two tongues 15, 15 project from an end of the high frequency substrate cover 12. The two tongues 15, 15 cover both ends of the hinge mechanism 3.

The battery pack 4 is detachably received via the support plate 6 in the battery chamber R of the cabinet body 14. Two nail pieces 17, 17 project from an end of the battery lid 41, and are inserted into two connection holes (not shown) provided on an end face of the high frequency substrate cover 12 that faces the battery chamber R. The antenna substrate cover 13 has a lock mechanism 16 for locking the battery pack 4. The lock mechanism 16 detachably locks the battery pack 4.

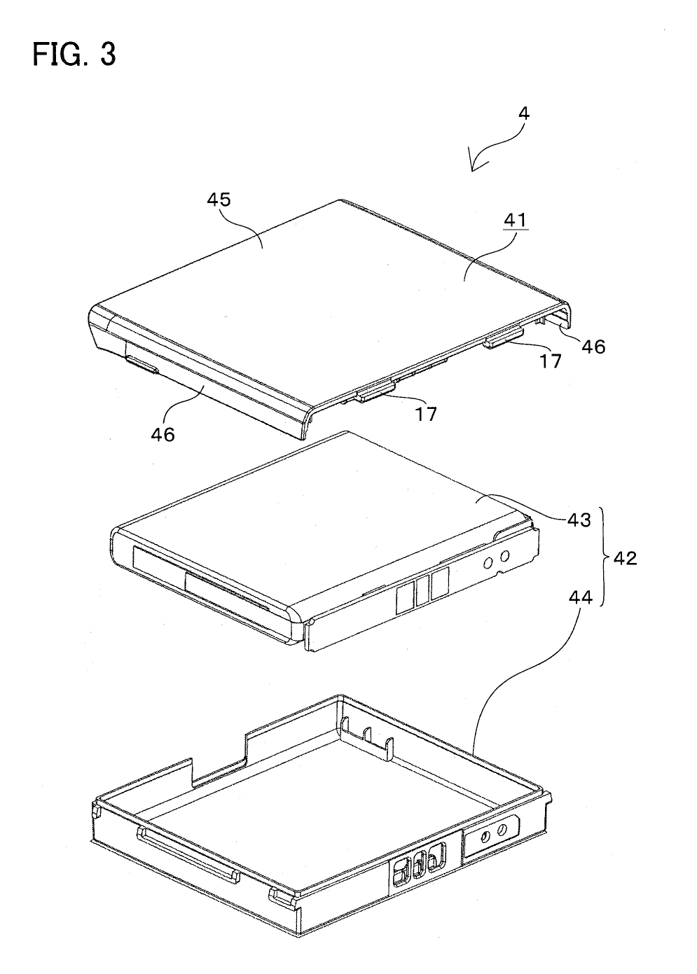

As shown in FIG. 3, the battery pack 4 includes a battery 42 and a battery lid 41 joined to the battery 42 by ultrasonic welding. The battery 42 includes a battery body 43 and a battery case 44 storing the battery body 43. The battery lid 41 has a main plate portion 45 ultrasonically welded to the battery 42 and two side plate portions 46, 46 connected to both ends of the main plate portion 45. The two nail pieces 17, 17 to be inserted into the two connection holes of the high frequency substrate cover 12 project from an end of the main plate portion 45.

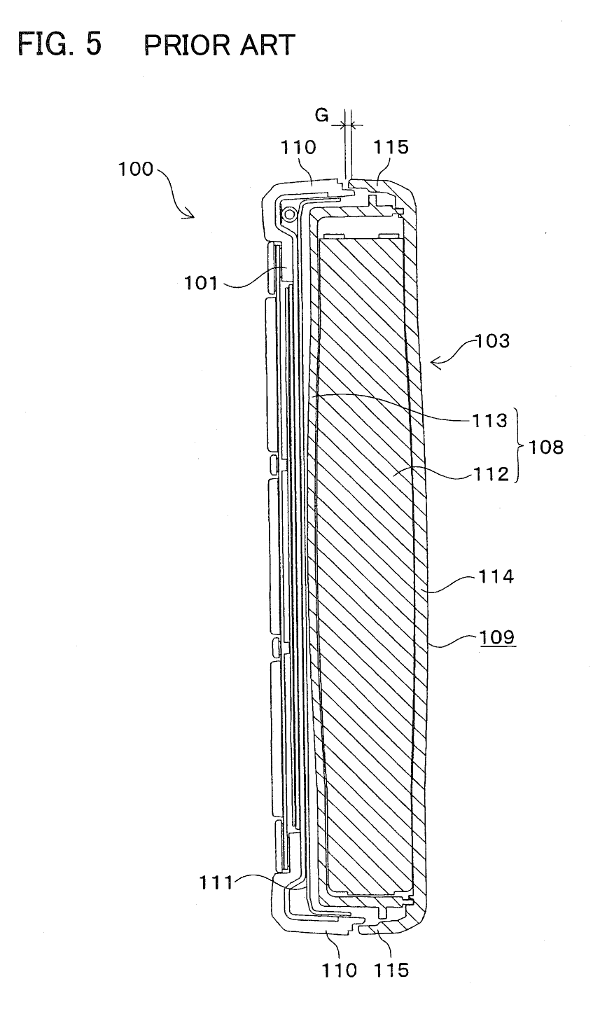

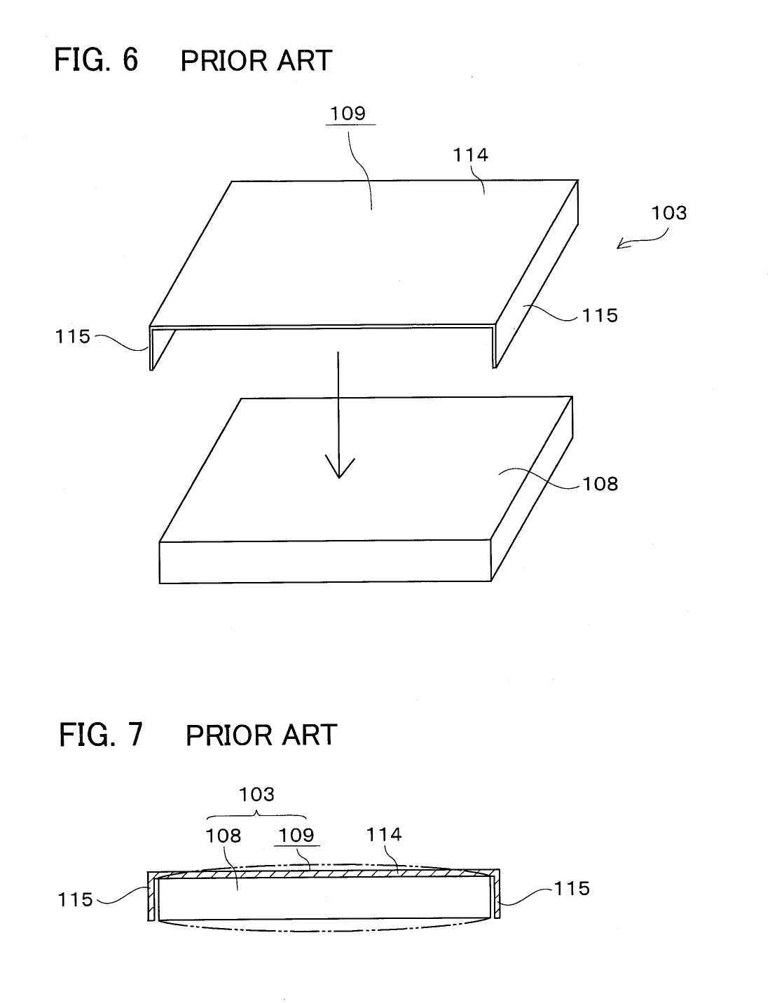

The battery pack 4 will be expanded in the thickness direction by using the battery pack 4 received in the battery chamber R of the cabinet body 14 under high temperature and high humidity environments. In the case of the conventional portable telephone 100, as shown in FIG. 5, the expansion of the battery pack 103 causes the battery pack 103 to press the support plate 111 covering the inside of the battery chamber R of the cabinet body 101, causing the reaction force thereof to raise the battery pack 103 outward from the battery chamber R. This results in each gap G being defined between the side plate portions 115, 115 of the battery lid 109 and the side plate portions 110, 110 of the cabinet body 101.

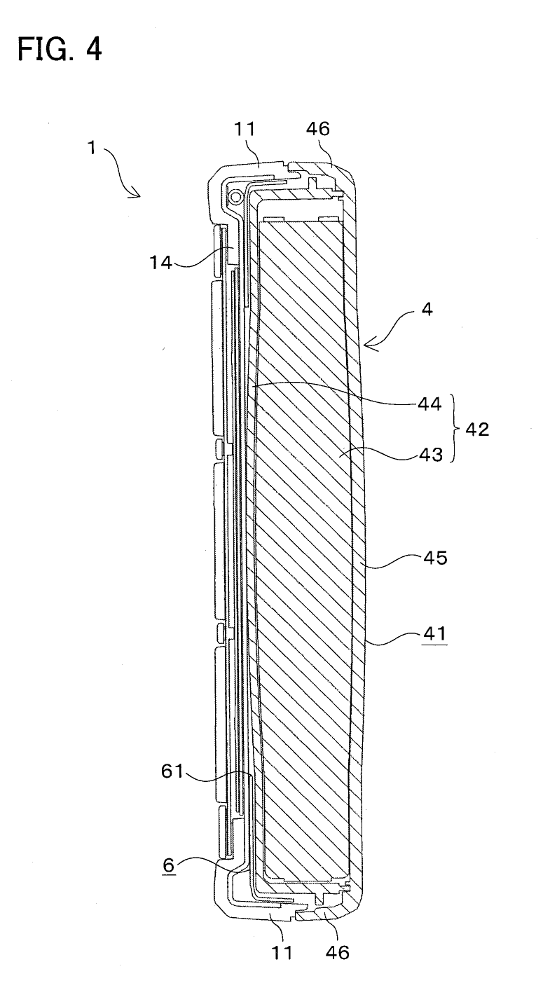

In contrast, in the case of the portable telephone of the present invention, as shown in FIG. 4, the opening 61 accommodates the expanded portion of the expanded battery pack 4 to thereby mitigate the force pressing the bottom face of the battery chamber R. This results in reducing the reaction force from the support plate 6 and the battery chamber R, preventing the battery pack 4 from being raised outward from the battery chamber R. This results in preventing a gap G from being defined between the side plate portions 46, 46 of the battery lid 41 and the side plate portions 11, 11 of the cabinet body 14.

The size of the opening 61 is determined in view of the strength of the material of the support plate 6, and may be at least within a range in which the support plate 6 can maintain mechanical strength to support the antenna substrate 53 and the high frequency substrate 52.

The present invention is not limited to the foregoing embodiment in construction but can be modified variously without departing from the spirit of the invention as set forth in the appended claims. Although the present invention embodied in a foldable portable telephone is described in the above described embodiment, the present invention is not limited to this but can be carried out in small electronic devices such as PHSs (Personal Handyphone Systems), laptop personal computers or the like.

What is claimed is:

1. A small electronic device comprising a cabinet body having a battery chamber defined therein, and a battery pack having a battery that is to be received in the battery chamber and is integrated with a battery lid for covering the battery chamber, the battery lid being detachably engaged with the cabinet body, wherein a support plate for receiving the battery is placed on the bottom face of the battery chamber, and an opening is centrally defined on the support plate.

2. The small electronic device according to claim 1, wherein the support plate is made of metal.

3. The small electronic device according to claim 2, wherein a first substrate and a second substrate are arranged on opposite sides across the battery chamber inside the cabinet body, with one of the substrates being connected to a ground potential, and the first substrate and the second substrate being electrically connected to each other by the support plate.

4. The small electronic device according to claim 3, wherein the first substrate is an antenna substrate having an antenna incorporated therein, and the second substrate is a high frequency substrate for performing communication processing using the antenna.
